(19) United States
(12) Patent Application Publication
(10) Pub. No.: US 2008/0252933 A1
(43) Pub. Date: Oct. 16, 2008

(54) Enhanced facsimile handling

(75) Inventors: Manoj Jain, Hederbad (IN); Archan Das, Hyderbad (IN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/786,526

(22) Filed: Apr. 12, 2007

(51) Int. Cl. H04N 1/00

(52) U.S. Cl. 358/402

(57) ABSTRACT

Described herein is technology for, among other things, facilitating transmissions of facsimiles by a computer. It involves various techniques for facilitating the preparation of a facsimile including storing the facsimiles in an editable format and initializing a fax application.

### BACKGROUND

As computer technology has advances, computers are used to perform an increasing number of tasks completely. One such task where computers are playing increasingly dominate roles is sending and receiving facsimiles. Built-in modems and the internet have enabled computers to operate as fax machines.

One problem using a computer as a fax device is because the inherent nature of facsimile transmissions requires transmitting images of the document being sent. This means that on a computer, a file must be converted into an image prior to being sent. Image conversion has several disadvantages. For example, the printed file may be stored as a temporary file and automatically removed after the fax transmission is complete. Furthermore, the requirement of printing means that the file cannot be easily updated or changed as the original file after it is printed. As another example, often files must be printed prior to being transmitted, which means the files must be opened and printed before the file can finally be sent via facsimile. Thus, a user may be required to open the file, go into a print menu, then select the fax printer, and then enter appropriate information before the fax can be sent. Further, if a user desires to fax multiple files, each one may be required to be printed and sent individually which can quickly become tedious. Thus, although computers can be used to transmit and received faxes, the processes for transmitting and receiving faxes are not all user friendly or intuitive.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, facilitating transmissions of facsimiles by a computer. It involves various techniques for facilitating the preparation of a facsimile including storing the facsimiles in an editable format and initializing a fax application.

In one implementation, the user may be presented with a contextual menu including an option for sending a file via facsimile. The default fax application is then invoked and the file to be faxed is communicated to the default fax application. The user may then be presented with the sending vehicle, such as a compose form, of the default fax application.

In another implementation, the user may invoke a fax application via a fax link within a file. Upon activating the link, the default fax application is determined and, if parameters are present in the link, the parameters may be communicated to the fax application. The default fax application then presents a sending vehicle for preparing and sending the fax.

In yet another implementation, a fax may be stored in a data structure suited for storing faxes. The data structure may be stored as a file format which allows faxes to be saved and edited as well as transferred around like other files. Files or other documents may be attached to faxes and stored within the fax file or as pointers or links within the fax file.

Techniques described herein provide preparation and sending of facsimiles without requiring users to print files prior to sending the fax. The user can also store and edit faxes. Thus, users are able to more easily prepare and send faxes via a computer.

### BRIEF DESCRIPTION OF THE DRAWINGS

The accompanying drawings, which are incorporated in and form a part of this specification, illustrate embodiments and, together with the description, serve to explain their principles:

FIG. 1 is a block diagram of an exemplary computing system environment for implementing an embodiment.

FIG. 2 is a flowchart of an exemplary process for faxing a file in accordance with an embodiment.

FIG. 3 is a flowchart of an exemplary process for presenting a menu to send a file via fax from within an application, in accordance with an embodiment.

FIG. 4 is a flowchart of an exemplary process for presenting a menu to send a file via fax from within a file handler application, in accordance with an embodiment.

FIG. 5 is a block diagram of an exemplary menu with an option to send a file via fax from within an application, in accordance with an embodiment.

FIG. 6 is a block diagram of an exemplary menu with an option to send a file via fax from with a file handler application, in accordance with an embodiment.

FIG. 7 is a flowchart of a process for initiating a fax from within a file, in accordance with an embodiment.

FIG. 8 is a block diagram of an exemplary system for faxing a file, in accordance with an embodiment.

FIG. 9 is a block diagram of an exemplary system for initiating a fax from within an application, in accordance with an embodiment.

FIG. 10 illustrates a block diagram of a data structure, which is stored on a computer-readable medium, in accordance with an embodiment.

### DETAILED DESCRIPTION

Reference will now be made in detail to the preferred embodiments of the claimed subject matter, examples of which are illustrated in the accompanying drawings. While the invention will be described in conjunction with the preferred embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present invention, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Overview

Described herein is technology for, among other things, facilitating transmissions of facsimiles by a computer. It involves various techniques for facilitating the preparation of a facsimile including storing the facsimiles in an editable format and initializing a fax application.

In one implementation, the user may be presented with a contextual menu including an option for sending a file via facsimile. The default fax application is then invoked and the file to be faxed is communicated to the default fax application. The user may then be presented with the sending vehicle, such as a compose form, of the default fax application.

In another implementation, the user may invoke a fax application via a fax link within a file. Upon activating the link, the default fax application is determined and, if parameters are present in the link, the parameters may be communicated to the fax application. The default fax application then presents a sending vehicle for preparing and sending the fax.

In yet another implementation, a fax may be stored in a data structure suited for storing faxes. The data structure may be stored as a file format which allows faxes to be saved and edited as well as transferred around like other files. Files or other documents may be attached to faxes and stored within the fax file or as pointers or links within the fax file.

Techniques described herein provide preparation and sending of facsimiles without requiring users to print files prior to sending the fax. The user can also store and edit faxes. Thus, users are able to more easily prepare and send faxes via a computer.

### Example Operating Environment

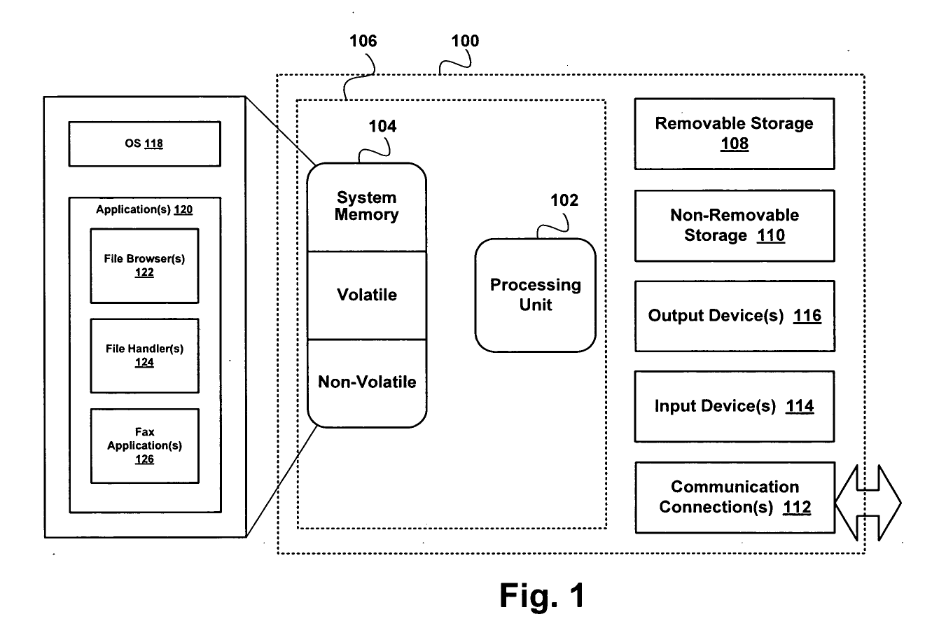

With reference to FIG. 1, an exemplary system for implementing embodiments includes a general purpose computing system environment, such as computing system environment 100. In its most basic configuration, computing system environment 100 typically includes at least one processing unit 102 and memory 104. Depending on the exact configuration and type of computing system environment, memory 104 may be volatile (such as RAM), non-volatile (such as ROM, flash memory, etc.) or some combination of the two. This most basic configuration is illustrated in FIG. 1 by dashed line 106.

System memory 104 may include, among other things, Operating System 118 (OS) and application(s) 120. In one embodiment, application(s) 120 may include: file browser(s) 122, file handler(s) 124, and fax application(s) 126. File browser(s) 122 may be applications that allow browsing and/or navigating folders and files on a storage medium. File handler(s) 124 may be applications that allow viewing and/or editing of files and may include: word processors, web browsers, spreadsheets, and document viewers. File browser(s) 122 and file handler(s) 124 may have menus for initiating faxes. Fax application(s) 126 may be applications that facilitate the sending or receiving of faxes. In one embodiment, fax application(s) 126 may save or store faxes in a specialized file format on a computer-readable storage medium. It is appreciated that file browser(s) 122, file handler(s) 124, and fax application(s) 126 may be part of an operating system such as OS 118 or may be separate applications.

Additionally, computing system environment 100 may also have additional features/functionality. For example, computing system environment 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and nonremovable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 100. Any such computer storage media may be part of computing system environment 100.

Computing system environment 100 may also contain communications connection(s) 112 that allow it to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 112 may also allow computing system environment 100 to communication with devices including, but not limited to, fax modems, fax machines, internet fax services, and fax printer devices.

Computing system environment 100 may also have input device(s) 114 such as a keyboard, mouse, pen, voice input device, touch input device, remote control, etc. Output device(s) 116 such as a display, speakers, etc. may also be included. All these devices are well known in the art and need not be discussed at length here.

The claimed subject matter is described in terms of these example environments. Description in these terms is provided for convenience only. It is not intended that the invention be limited to application in this example environment. In fact, after reading the following description, it will become apparent to a person skilled in the relevant art how to implement the claimed subject matter in alternative embodiments.

### Example Operations

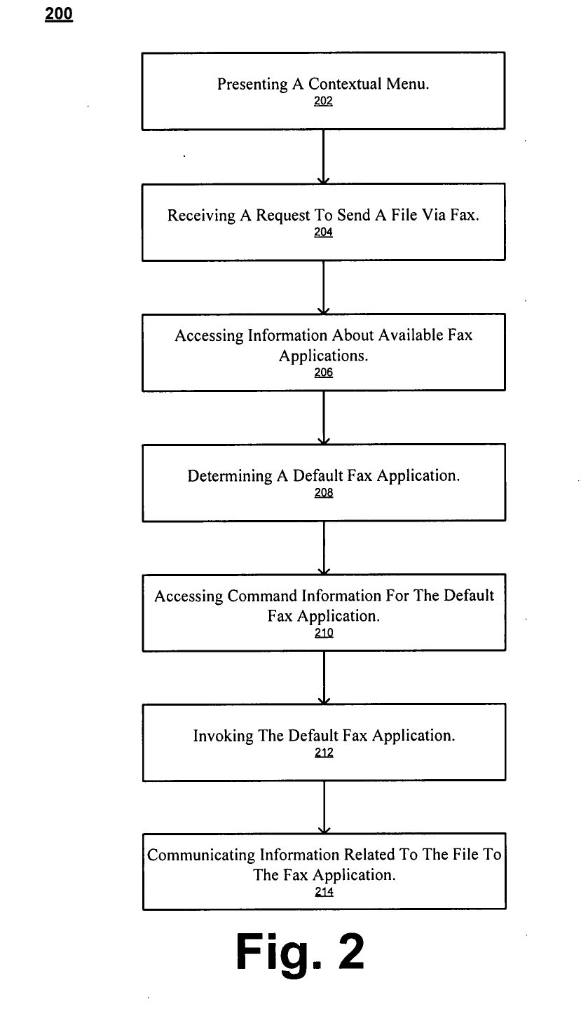

The following discussion sets forth in detail the operation of the present technology for enhanced facsimile handling. With reference to FIGS. 2-4 and 7, flowcharts 200, 202A, 202B, and 700 each illustrate example blocks used by various embodiments of the present technology. Flowcharts 200, 202A, 202B, and 700 include processes that, in various embodiments, are carried out by a processor under the control of computer-readable and computer-executable instructions. The computer-readable and computer-executable instructions reside, for example, in data storage features such as computer usable memory 104, removable storage 108, and/or non-removable storage 110 of FIG. 1. The computer-readable and computer-executable instructions are used to control or operate in conjunction with, for example, processing unit 102 of FIG. 1. Although specific blocks are disclosed in flowcharts 200, 202A, 202B, and 700, such blocks are examples. That is, embodiments are well suited to performing various other blocks or variations of the blocks recited in flowcharts 200, 202A, 202B, and 700. It is appreciated that the blocks in flowcharts 200, 202A, 202B, and 700 may be performed in an order different than presented, and that not all of the blocks in flowcharts 200, 202A, 202B, and 700 may be performed.

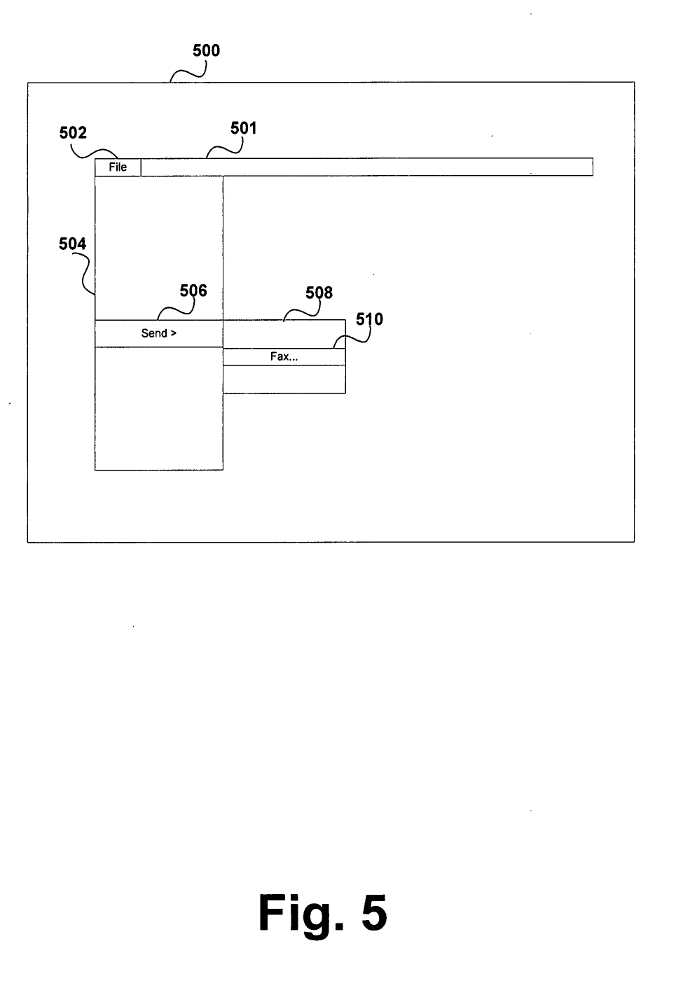

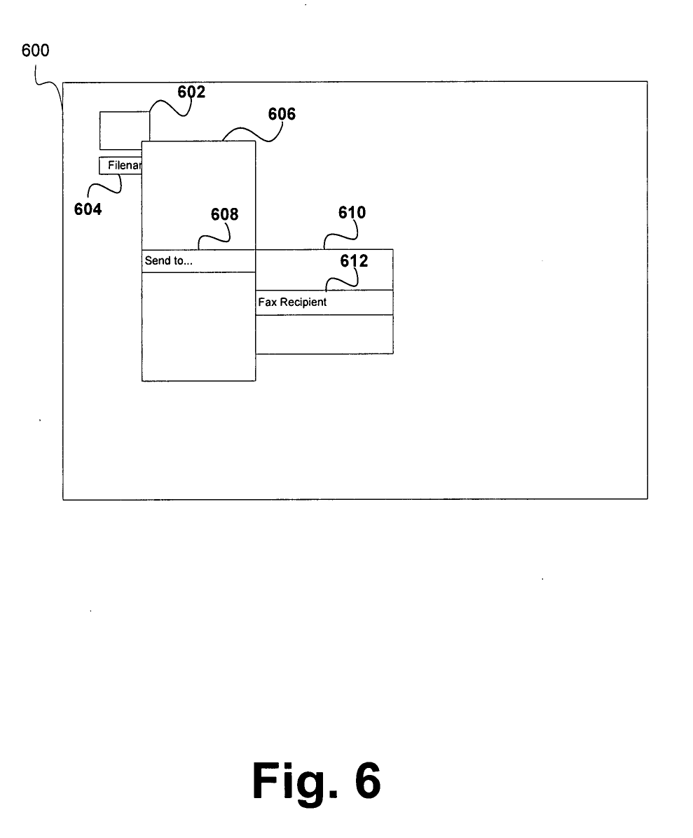

FIG. 2 is a flowchart 200 of an exemplary process for faxing a file, in accordance with an embodiment. For the purpose of illustration, and not for limitation, flowchart 200 may be described with reference to FIGS. 5 and 6, which illustrate exemplary graphical user interfaces 500 and 600 for presenting an option for sending a file via fax, in accordance with various embodiments.

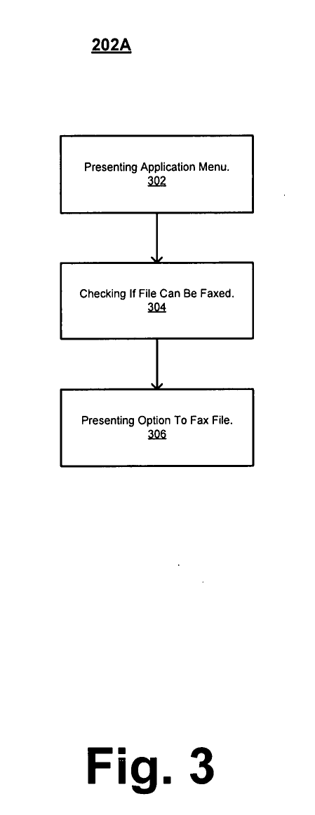

At block 202, a contextual menu is presented. It is appreciated that this may be achieved in a number of ways. For example, FIG. 3 shows an exemplary flowchart 202A for presenting contextual menus such as those shown in FIG. 5.

At block 302, an application menu is presented. An application menu may be part of an application or file handler for viewing and/or editing a file, including but not limited to a word processor, web browser, or spreadsheet program. An application menu may be displayed as a menu bar 501 across the top of a graphical user interface 500. Menu bar 500 may have a plurality of menu items such as exemplary file menu 504. File menu 504 may have a plurality of menu items such as send menu item 506. A menu item may have a sub menu such as submenu 508 which is a submenu of send menu item 506. Submenu 508 may have a plurality of menu items, such as fax menu item 510. Fax menu item 510 may be used to initiate a request to send a file via fax. It is appreciated menus may be structured in a variety of ways other than described herein and not limited as such.

At block 304, a check is performed to determine if the file can be faxed. The check may be done via an application programming interface (API). For example, an API call may be made that returns a boolean value as to whether the file can be printed and thus can be sent via a fax.

At block 306, the option to fax the file is presented. Alternatively if the previous block determines that the file can not be faxed, the option to fax the file may be disabled. An exemplary option to fax a file is shown by fax menu item 510 in FIG. 5. Thus, when viewing a file in an application, a user may select a file menu, a send submenu, and a fax menu item.

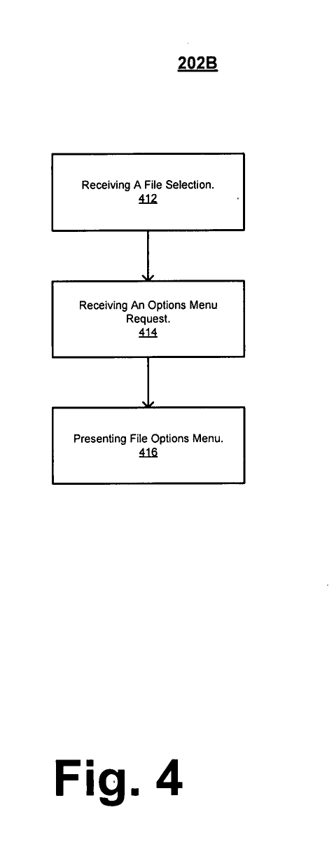

FIG. 4 illustrates a flowchart 202B for a process of presenting the menu in a file browser, in accordance with various embodiments. A file browser may be an application that allows navigation of the various files and folders available on a computer system as described above. It is appreciated that a file browser may be part of numerous applications, such as an open dialogue window of a word processor. FIG. 6 shows an exemplary menu that may be part of a graphical user interface 600 for a file browser. A file may be represented by an icon 602 and corresponding filename 604.

At block 412, a file selection is received via mouse click or key press and contextual menu 606 may be invoked by a mouse click or a key press.

At block 414, a request for an options menu is received. The request may be made via a mouse click or a key press. For example, the options request may have been made by a user clicking the right mouse button.

At block 416, a file options menu is presented. In addition to menu 606, it is appreciated that the options menu may be part of a menu bar across the top of a graphical user interface, similar to menu bar 501 of FIG. 5. It should be further appreciated that other types of menus, in addition to those depicted in FIGS. 5 and 6, may be used instead.

Menu 606 is an exemplary options menu and may have a plurality of menu items such as a send to menu item 608. Menu items may have submenus such as submenu 610 of send to menu item 608 which have a plurality of menu items such as fax recipient 612. Fax recipient menu item 612 may be used to initiate a request to fax a file.

Referring back to FIG. 2, at block 204 a request is received to send a file via fax. The request may have been made by selecting a menu item corresponding to sending a file via fax, such as fax menu item 410 or fax recipient menu item 512. In the case where the menu item corresponding to sending the file by fax is within an application, an API call may be made to send the file via fax. For example, sending a file via fax may be initiated by making a call to a SendToFaxRecipient API which may take arguments such as sending mode and filename.

At block 206, information about available fax applications is accessed. The information may be available through an operating system. For example, a list of fax applications may be maintained along with other settings and configurations in a registry, database, or other data structure which can be accessed by making requests to an operating system. In one embodiment, an API call may invoke a process which accesses fax application information maintained by an operating system.

At block 208, a default fax application is determined. A computer system may have several fax applications installed, some which are included in the operating system and others that were developed by a third party, thus a fax application to send the file needs to be determined. The default fax application may be determined based on configuration information identifying a specific fax application as the default fax application. In one embodiment, the information may be available through the operating system as described above. For example, a list of available or installed and default fax applications may be stored in the registry of the operating system. Alternatively, the default fax application can be determined based on being the only fax application available. Further, an API call to send a file via fax may invoke a library which accesses information available via the registry of an operating system and determines the default fax application.

At block 210, command information for the default fax application is accessed. The command information may be parameters or arguments for the fax application such as a filename or sending information. In one embodiment, the command information may be available via a shortcut or link. In another embodiment, an API call may invoke a process to access or access directly fax application command information.

At block 212, the default fax application is invoked. The default fax application may be invoked via an application programming interface. The default fax application may also be initiated via a command line command with appropriate command line switches from the command information accessed above. For example, a command line switch may specify the file to be attached to the fax. The default fax application and switch may be stored in a shortcut or program reference and used to invoke the default fax application.

At block 214, information related to the file is communicated to the fax application. For example, the filename of the file to be faxed may be communicated to the fax application. The information may be communicated through an application programming interface or as command information, such as a command line switch, as described above.

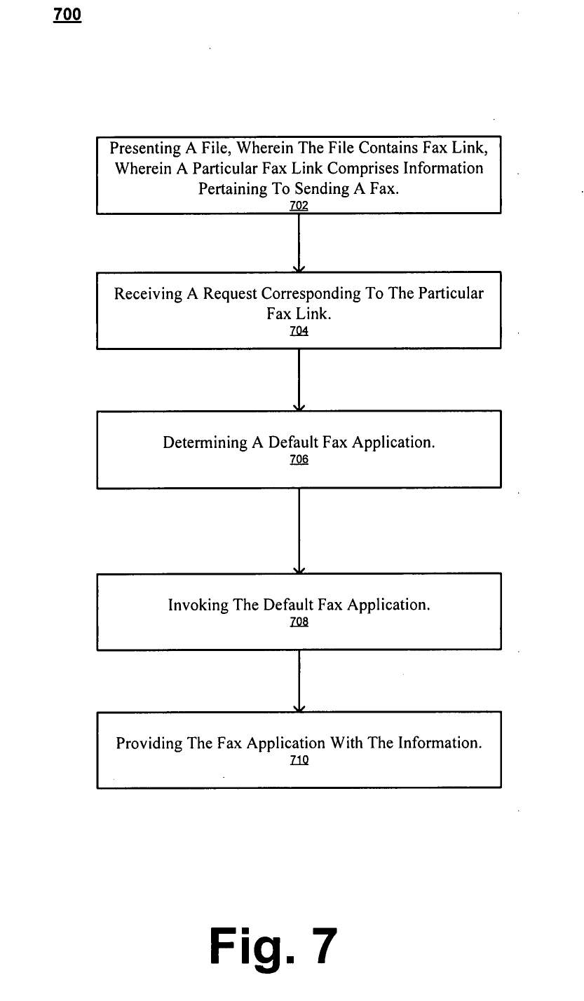

Initiation of a fax may also be handled as a link within a document. FIG. 7 is a flowchart 700 of an exemplary process for faxing a file, in accordance with an embodiment.

At block 702, a file is presented which contains a fax link. The file may be presented in various computer applications such as a web browser, word processor, or document viewer. The fax link may be formatted as a hypertext markup language (HTML) link. For example, the link may be formatted as “<a href=faxto:999-999-9999>Link text</a>”, where the fax will be sent to 999-999-9999. The fax may also be formatted to send to a contact in an address book. For example, the fax link may be formatted as “<a href=faxto:John Doe>Link text</a>”, where the fax will be sent to the fax number associated with the address book entry for John Doe.

The fax link may also include additional information. For example, the fax link could contain one or more recipients and be formatted as “<a href=faxto:999-999-9999,999-999-9990>Link name</a>” where the fax will be sent to 999-999-9999 and 999-999-9990. The fax link may also contain a subject and for example be formatted as “<a href=faxto:999-999-9999?subject=fax subject>Link name</a>” where the subject of the fax will be “fax subject”.

Further, the fax link may contain information relating to the body of the fax. For example, the fax link may be formatted as “<a href=faxto:999-999-9999?body=fax message>Link name</a>”, where the body will be “fax message”. The information relating to the body may also specify a file to be attached. For example, the fax link may be formatted as “<a href=faxto:999-999-9999?file=c:\order.txt>Link name</a>”, where the file order.txt will be attached to the fax.

The fax link may further contain carbon copy (CC) and blind carbon copy (BCC) information. Multiple pieces of information may be appended with an ‘&’ between each other. For example, the link may be formatted as “<a href=faxto:999-999-9999?cc=888-888-8888&bcc=777-777-7777>Link name</a>”.

At block 704, a request corresponding to the particular fax link is received. The request may have been made via a mouse click or a key press from within the application presenting the file.

At block 706, the default fax application is determined. A computer system may have several fax applications installed, some which are included in the operating system and others that were made by a third party, thus a fax application to send the fax will need to be determined. The default fax application may be determined based on configuration information identifying a specific fax application as the default fax application. Such information may be available through the operating system. For example, a list of fax applications may be maintained along with other settings and configurations in a registry, database, or other data structure which can be accessed by making calls to the operating system. Alternatively, the default fax application may be determined based on being the only fax application available.

At block 708, the default fax application is invoked. The information accessed in determining the default fax application may also include information about providing arguments and parameters to the fax application. After being invoked, the fax application may present a sending vehicle such as a compose form or a wizard which the user can complete and then send the fax.

At block 710, the fax application is provided with the information within the fax link. The information provided may be the various pieces of information discussed above including multiple recipients, subject, body, and a file to be attached. The information may be used by the fax application to populate or fill in the corresponding fields of a fax application sending vehicle such as a compose form or wizard. Thus, a user will be able to more easily and quickly send a fax as fields will already be completed.

### Example Fax System

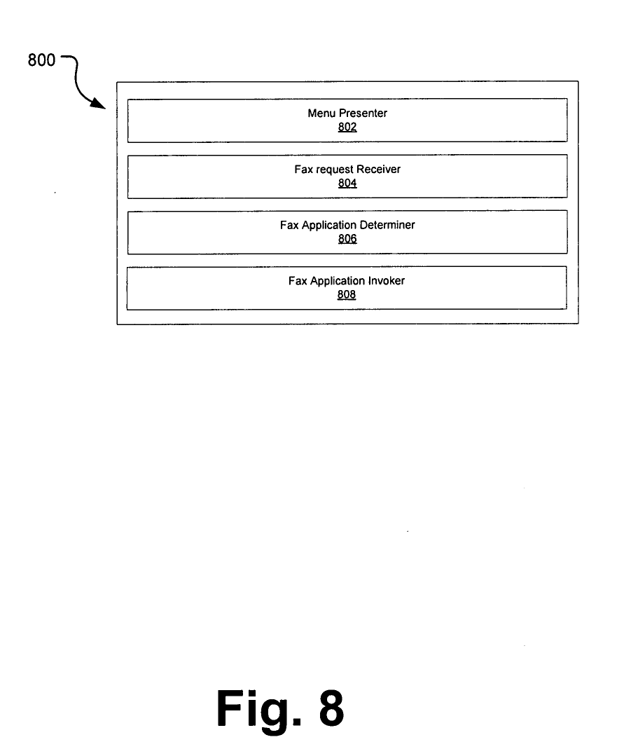

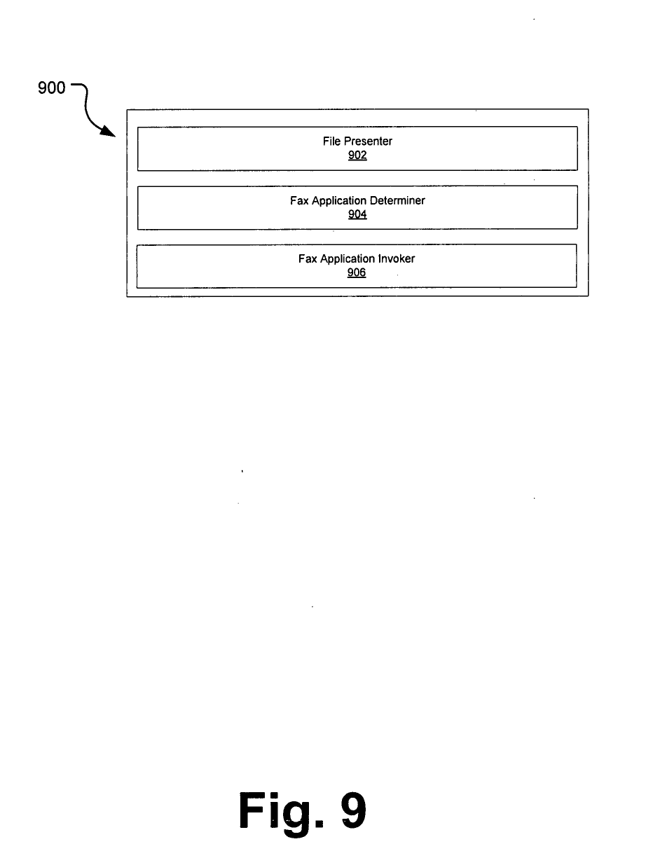

The following discussion sets forth in details of the present technology systems for enhanced facsimile handling. With reference to FIGS. 8 and 9, each illustrate example components used by various embodiments of the present technology. Systems 800 and 900 include components or modules that, in various embodiments, are carried out by a processor under the control of computer-readable and computer-executable instructions. The computer-readable and computer-executable instructions reside, for example, in data storage features such as computer usable memory 104, removable storage 108, and/or non-removable storage 110 of FIG. 1. The computer-readable and computer-executable instructions are used to control or operate in conjunction with, for example, processing unit 102 of FIG. 1. It should be appreciated that the aforementioned components of systems 800 and 900 can be implemented in hardware or software or in a combination of both. Although specific components are disclosed in systems 800 and 900 such components are examples. That is, embodiments are well suited to having various other components or variations of the components recited in systems 800 and 900. It is appreciated that the components in systems 800 and 900 may operate with other components than those presented, and that not all of the components of systems 800 and 900 may be required to achieve the goals of systems 800 and 900.

FIG. 8, shows a block diagram of an exemplary system for faxing a file, in accordance with an embodiment. System 800 includes menu presenter 802, fax request receiver 804, fax application determiner 606, and fax application invoker 808.

Referring to FIG. 8, menu presenter 802 presents menus on a graphical user interface. It is appreciated that menus may be presented in various ways and layouts. For example, the menus may be presented in a substantially similar manner as described above and are not limited as such.

Fax request receiver 804 receives requests for a file or files to be faxed. It is understood that requests may be received in numerous ways, such as, described above and are not limited as such. For example, fax request receiver 804 may receive requests for files to be faxed via the menus presented as described above.

Fax application determiner 806 determines the default fax application that will be used to send the fax. It is appreciated that a default fax application may be determined in many ways. For example, the default fax application and associated parameters and arguments may be determined as described above and are not limited as such.

Fax application invoker 808 invokes the default fax application. It is appreciated that a fax application may be invoked in various ways. For example, the default fax application may be invoked and provided with appropriate parameters or arguments, such as the filename, as described above and not limited as such.

FIG. 9, shows a block diagram of an exemplary system for initiating a fax from within an application, in accordance with an embodiment. System 900 includes file presenter 902, fax application determiner 904, and fax application invoker 906.

File presenter 902 presents files which contain fax links as described above and not limited as such. It is appreciated that file presenter 902 may be part of numerous applications such as a web browser, word processor, or spreadsheet. The fax links may be formatted as described above, but are not limited as such.

Fax application determiner 904, determines the default fax application to be used to compose and/or send the fax. It is understood that the default fax application may be determined various ways. For example, the default fax application may be determined as described above and is not limited as such.

Fax application invoker 906, invokes the default fax application. It is appreciated that a fax application may be invokes in many ways. For example, fax application invoker 906 may invoke the default fax application and provide the information available from within the fax link as described above and not limited as such.

### Example Data Structure

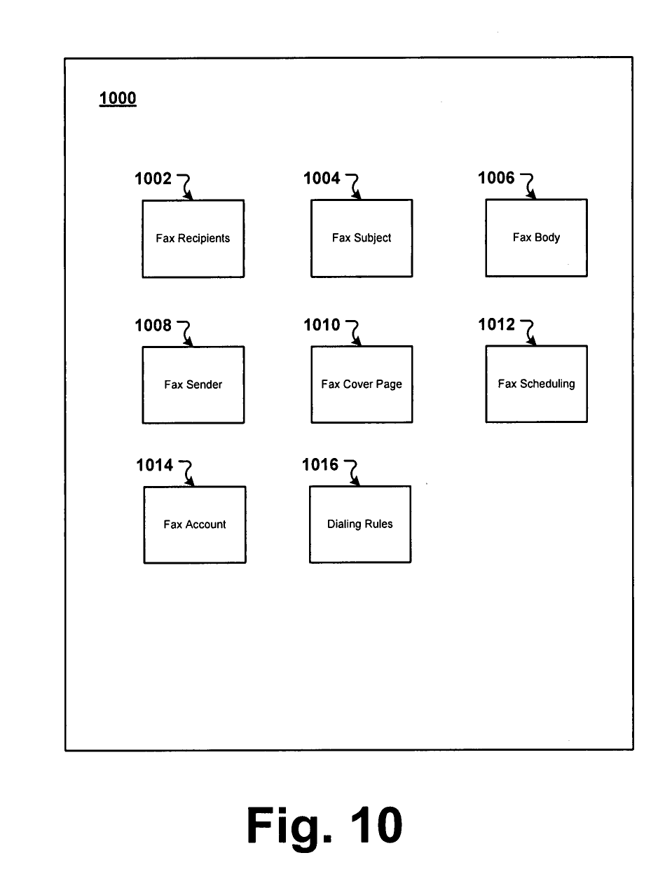

FIG. 10 shows a block diagram of a data structure 1000, which is stored on a computer-readable medium, in accordance with an embodiment. It is appreciated that not all data fields of data structure 1000 are necessary for the general goal of data structure 1000 to be achieved. Moreover, it is appreciated that additional data fields may also be included in data structure 1000 in accordance with various embodiments.

Data structure 1000 may also be stored as a file on computer-readable medium and have an associated extension. In one embodiment, data structure 1000 is file format suited for storing faxes and associated fax data. The storing of data structure 1000 in a file allows a fax to be edited, saved as drafts, and moved to different computer systems. The ability to save and edit fax in files overcomes the problem associated with conventional fax solutions where a fax is printed to a file and is not easily modified. Files or documents attached to a fax may be stored in the fax file format or stored as links or pointers within the file. For example, data structure 1000 may have a .fml, .fax, etc., extension, and when a request is made to open the file, it may be opened with the corresponding fax application if the fax file format is specific to the application. In another example, a COM (Component Object Model) server determines and invokes the default fax application with appropriate parameters such as filename or message ID. In one embodiment, data structure 1000 may be stored in a MIME (Multipurpose Internet Mail Extensions) format. Thus, data structure 1000 may allow faxes to be treated similar to emails and advantageously be stored in folders and sent around via emails, file transfers, etc.

Data structure 1000 includes a first data field 1002 representing one or more fax recipients. The fax recipients may be represented by telephone numbers, address book contacts, or groups of recipients. Data structure 1000 also includes a second data field 1004 representing the subject of a fax. Data structure 1000 further includes a third data field representing a body of a fax. For example, the contents of a file maybe serialized or content of a file stored within the third data field of data structure 1000.

Data structure 1000 may also include a fourth data field 1008 representing fax sender information. For example, fourth data field 1008 may include the sender's: name, company, fax number, address, country, title, department, office locations, home phone number, office phone numbers, email address, billing codes, and transmission signal identification (TSID).

Data structure 1000 may also include a fifth data field 1010 representing fax cover page information. For example, fifth data field 1010 may include notes that are to be placed on the cover page, privacy level such as confidential, and whether a server cover page or general cover page is to be used.

Data structure 1000 may further include a sixth data field 1012 representing fax scheduling information. For example, the sixth data filed 1012 may include the time a fax is to be sent and the type or priority of scheduling.

Data structure 1000 may also include a seventh data field 1014 representing fax account information. For example, seventh data field 1014 may include information about the account of the sender or fax billing account.

Data structure 1000 may further include an eighth data field 1016 representing various dialing rules for sending a fax. For example, eighth data field 1016 may contain rules for dialing a number to access an outside line, international numbers or calling card information.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for faxing a file stored on a computer, the method comprising:
presenting a contextual menu;
receiving a request to send the file via fax;
determining a default fax application;
invoking said default fax application; and
communicating information related to said file to said fax application.

2. The method as recited in claim 1 wherein said contextual menu is presented via a file browser.

3. The method as recited in claim 1 wherein said contextual menu is presented within an application for viewing the contents of said file.

4. The method as recited in claim 1 wherein said fax application is invoked via an application programming interface.

5. The method as recited in claim 1 further comprising:
checking if said file can be faxed.

6. The method as recited in claim 1 further comprising:
accessing information comprising available fax applications.

7. The method as recited in claim 6 wherein said information is available though an operating system.

8. The method as recited in claim 1 further comprising:
accessing command information for said default fax application.

9. A method for initiating a fax from within an application, the method comprising:
presenting a file, wherein said file contains a fax link that includes information pertaining to sending a fax;
receiving a request corresponding to said fax link;
determining a default fax application;
invoking said default fax application; and
providing said fax application with said information.

10. The method as recited in claim 9 wherein said link is formatted as an HTML link.

11. The method as recited in claim 9 wherein said information comprises one or more recipients.

12. The method as recited in claim 9 wherein said information comprises a body of a fax message.

13. The method as recited in claim 9 wherein said information comprises a contact in an address book.

14. The method as recited in claim 9 wherein said information comprises a subject of a fax.

15. The method as recited in claim 9 wherein said information comprises a link to a file to be attached to said fax.

16. A computer-readable medium having stored thereon a data structure for storing a fax, comprising:
a first data field representing one or more fax recipients;
a second data field representing a subject of a fax; and
a third data field representing a body of a fax.

17. The computer-readable medium as recited in claim in 16 further comprising:
a fourth data field representing fax sender information.

18. The computer-readable medium as recited in claim 17 further comprising:
a fifth data field representing fax cover page information.

19. The computer-readable medium as recited in claim 19 further comprising:
a sixth data field representing a scheduled fax time.

20. The computer-readable medium as recited in claim 16 wherein said third data field comprises an attached file.
